(19) United States
(12) Patent Application Publication
(10) Pub. No.: US 2006/0156080 A1
(43) Pub. Date: Jul. 13, 2006

(54) Method for the thermal testing of a thermal path to an integrated circuit

(75) Inventors: John P. Tellkamp, Denison, TX (US); Sandra J. Horton, Farmers Branch, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/009,290

(22) Filed: Dec. 10, 2004

(51) Int. Cl. G11B 20/20; G06K 5/04; G11B 5/00

(52) U.S. Cl. 714/700

(57) ABSTRACT

According to one embodiment of the present invention, a method for detecting a defect in an integrated circuit using an optimized power pulse includes applying a first pulse of power to a first integrated circuit for an optimized pulse duration. The optimized pulse duration is determined as a function of a difference in temperature between a second, defective integrated circuit and a third, non-defective integrated circuit. The temperature of the first integrated circuit is measured after the first pulse of power is applied to the first integrated circuit for the optimized pulse duration, and a determination is made as to whether the first integrated circuit is defective based on the temperature of the first integrated circuit.

### TECHNICAL FIELD OF THE INVENTION

This invention relates generally to the field of semiconductor devices and, more particularly, to a method for the thermal testing of a thermal path to an integrated circuit.

### BACKGROUND OF THE INVENTION

An integrated circuit dissipates power primarily in the form of heat. Typical semiconductor devices have an ambient operating temperature range from 0 to 70° C., although some devices have ambient operating temperatures beyond this range. For the dissipation of heat, typical semiconductor dies are packaged such that heat generated during operation of the de ice is transferred along one or more thermal paths. For example, the heat may travel by conduction through the die attach material, die pad, and solder joints where it may be absorbed by a printed circuit board (PCB). Alternatively, the heat may travel to an externally mounted metallic heat sink attached to the surface of the integrated circuit.

Defects in the thermal path affect the ability of the device to dissipate heat. For example, a defect in the adherence of the die to the die pad, such as a void or delamination in the die attach material, may reduce the ability of the integrated circuit to conductively transfer heat. As a result, the temperature of the integrated circuit may rise to a level that is above the normal or recommended operating range. As the temperature of the integrated circuit increases, the performance of the integrated circuit may be degraded. Accordingly, the lifespan of the integrated circuit may be reduced, the integrated circuit may operate at slower speeds or fail altogether, or the integrated circuit may display other non-ideal operating characteristics.

### SUMMARY OF EXAMPLE EMBODIMENTS

From the foregoing it may be appreciated by those skilled in the art that a need has arisen for a system and method for the detection of defects in an integrated circuit using thermal sensing. In accordance with the present invention, a system and method for detecting a defect in an integrated circuit using an optimized electrical pulse is provided that substantially eliminates or greatly reduces disadvantages and problems associated with conventional thermal measuring techniques.

According to one embodiment of the present invention, a method for detecting a defect in an integrated circuit using an optimized power pulse includes applying a first pulse of power to a first integrated circuit for an optimized pulse duration. The optimized pulse duration is determined as a function of a difference in temperature between a second, defective integrated circuit and a third, non-defective integrated circuit. The temperature of the first integrated circuit is measured after the first pulse of power is applied to the first integrated circuit for the optimized pulse duration, and a determination is made as to whether the first integrated circuit is defective based on the temperature of the first integrated circuit.

According to another embodiment of the present invention, a method for determining an optimized pulse duration for detecting defects in integrated circuits includes providing a first integrated circuit known to be defective. The temperature of the first integrated circuit is measured at a plurality of predetermined increments of time as a first power pulse is applied to the first integrated circuit. A second integrated circuit known to be non-defective is provided, and the temperature of the second integrated circuit is measured at the plurality of predetermined increments of time as a second power pulse is applied to the integrated circuit. A difference in temperature between the first integrated circuit and the second integrated circuit is determined at each of the plurality of predetermined increments, and an optimized pulse duration for determining whether a third integrated circuit is defective is determined. The optimized pulse duration includes an increment of time corresponding with the greatest difference in temperature between the first integrated circuit and the second integrated circuit.

Certain examples of the invention may provide one or more technical advantages. A technical advantage of one exemplary embodiment of the present invention is that an optimized electrical pulse duration for performing thermal functionality tests on integrated circuits may be determined. The optimized electrical pulse may be a sufficient length of time to measure the thermal capacitance of the packaged integrated circuit (device), as well as the thermal path from the package to the PCB. A further technical advantage of one exemplary embodiment of the present invention is that the property measured during thermal testing may indicate the efficiency of one or more critical interfaces in the die package to dissipate heat. For example, the thermal functionality tests may detect the presence of any voids in the epoxy or other material adhering the die to the die pad. As another example, the thermal functionality tests may detect the presence of any voids in the solder or other material adhering the die pad to the printed circuit board or other heat sink. As a result, die packages having delamination defects may be removed from production so that defective semiconductor devices are not incorporated into end products. Accordingly, the performance of end products including die packages such as those being tested may be improved and operating temperatures reduced.

Other technical advantages may be readily apparent to one skilled in the art from the figures, descriptions and claims included herein. None, some, or all of the examples may provide technical advantages.

### BRIEF DESCRIPTION OF THE DRAWINGS

For a more complete understanding of the present invention and its features and advantages, reference is now made to the following description, taken in conjunction with the accompanying drawings, in which:

FIG. 1 is a top view of a thermal testing system in accordance with an embodiment of the present invention;

FIG. 2 is a cross-sectional view of a mounted integrated circuit in accordance with an embodiment of the present invention; and

FIGS. 3A-3B are graphs illustrating example temperature measurements obtained for the determination of an optimized electrical pulse duration for detecting a defect in a thermal path to an integrated circuit in accordance with an embodiment of the present invention.

### DETAILED DESCRIPTION OF EXAMPLE EMBODIMENTS

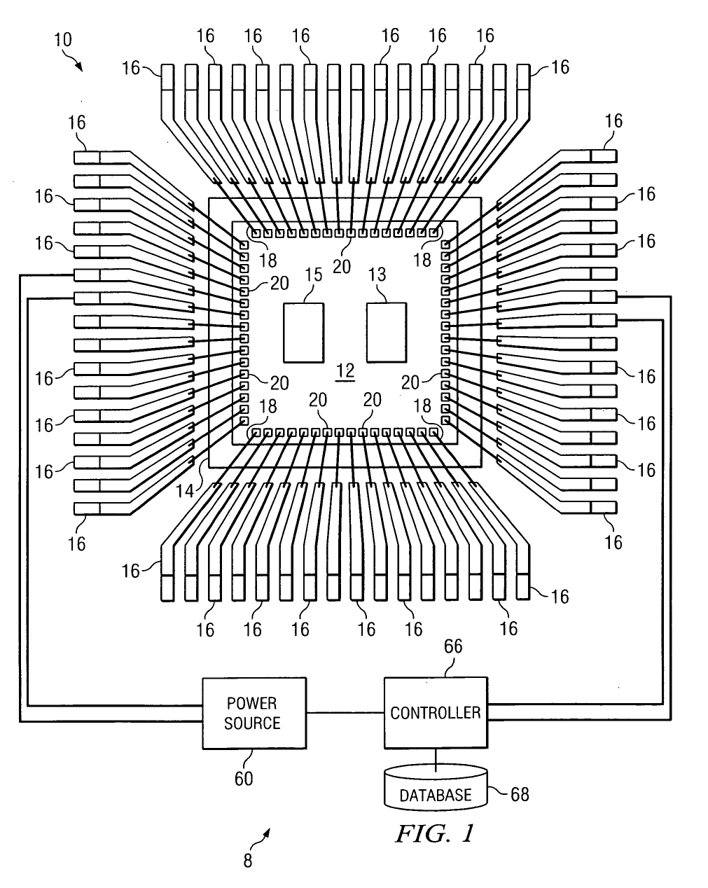

The preferred embodiments of the present invention and its advantages are best understood by referring now in more detail to FIGS. 1-3 of the drawings, in which like numerals refer to like parts.

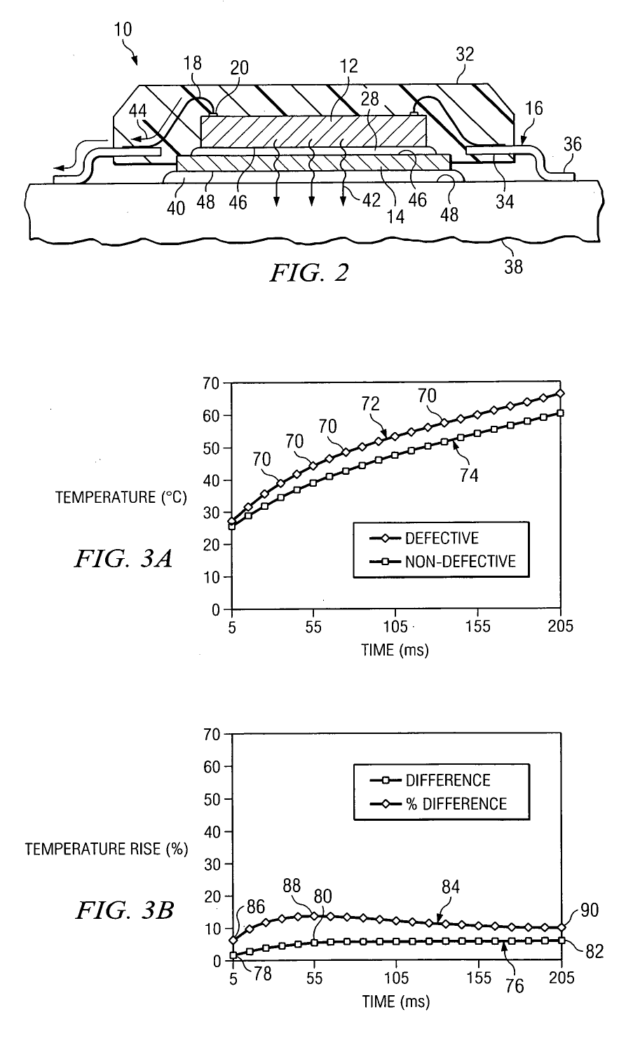

A thermal testing system 8 for the testing of a standard packaged integrated circuit 10 is shown in FIG. 1. Packaged integrated circuit 10 is shown, however, without the outer plastic molding that is typically formed to at least partially encase packaged integrated circuit 10 (illustrated in FIG. 2). Packaged integrated circuit 10 includes a die 12 supported on and/or bonded to a die pad 14. In particular embodiments, die 12 may comprise silicon, gallium arsenide, or other suitable substrate material. Die 12 may provide the foundation in which one or more semiconductor features, such as regions 13 and 15, may be created using a variety of techniques and procedures, such as layering, photolithographic patterning, doping through implantation of ionic impurities, and heating. Regions 13 and 15 and other features on die 12 may include analog and/or digital circuits such as digital to analog converters, computer processor units, amplifiers, digital signal processors, controllers, transistors, or any combination of these or other high-temperature devices.

In the illustrated example, die 12 is supported on die pad 14. Die pad 14 may include a substrate material such as copper alloy, nickel alloy, aluminum, or another appropriate substrate material. Packaged integrated circuit 10 also includes a leadframe 16 to provide external connections to packaged integrated circuit 10. Leadframe 16 may be made from any conductive material, such as copper, aluminum, or other suitable metal. Lead wires 18 electrically couple die 12 to leadframe 16 when die 12 is supported on die pad 14. Specifically, lead wires 18 may be coupled between bond pads 20 and leads of leadframe 16. In certain embodiments, lead wires 18 may be made from any suitable conductive material, such as aluminum or gold. Lead wires 18 form an electrical connection between die 12 and the individual leads making up leadframe 16.

Although the packaged integrated circuit 10 of FIG. 1 is illustrated as including die pad 14, lead frame 16, lead wires 18, and bond pads 20, it is recognized that packaged integrated circuit 10 is merely one example of a semiconductor device on which thermal sensing may be performed. Packaged integrated circuit 10 may include more, less, or different components than those illustrated. For example, in particular embodiments, it is generally recognized that packaged integrated circuit 10 may include a flip chip that is soldered indirectly or directly to a printed circuit board (PCB) or may be configured in any other appropriate manner.

In particular embodiments, and after the appropriate electrical connections have been made in and to die 12 by wire bonding or other point to point connection methods, die 12 may be encapsulated or partially encapsulated in a plastic moulding compound and mounted to a printed circuit board. FIG. 2 is a cross-sectional view of a mounted packaged integrated circuit 10 in accordance with an embodiment of the present invention. In certain embodiments, die 12 is attached to die pad 14 by a die attach medium 28, which may be composed of a compound of Epoxy, Polyimide, or other adhesive chemistry or a mixture of such chemistries. Alternatively die attach medium 28 may include solder, a gold-silicon Eutectic layer, or other suitable material for bonding die 12 to die pad 14. In various embodiments, die attach medium 28 establishes both a mechanical and thermal connection between die 12 and die pad 14.

In the illustrated embodiment, die 12 and die pad 14 are at least partially encapsulated in a block of plastic or other molded body 32 using conventional semiconductor fabrication packaging processes die 12 may be said to be at least partially encapsulated where one side of die pad 14 is exposed through molded body 32. Where packaged integrated circuit 10 includes a leadframe 16, molded body 32 may also encapsulate a portion of leadframe 16. As can be seen from the view depicted in the example embodiment illustrated in FIG. 2, each lead of leadframe 16 includes a first end 34 and a second end 36 that are doglegged from one another. Molded body 32 is configured to encapsulate a portion of first end 34, whereas second end 36 extends outside of molded body 32. The doglegging of leadframe 16 facilitates the mounting of packaged integrated circuit 10 to a printed circuit board (PCB) 38 since second end 36 of leadframe 16 is below the level of the bottom of molded body 32.

In operation, region 15 and other features formed in and/or on die 12 generate heat that may be dissipated from die 12 to PCB 38 along one or more thermally conductive paths. Generally, there may be several thermal paths that may include convection through the top of molded body 32, conduction through leads 16, and conduction through exposed die pad 14. For example, heat may be dissipated along a primary conductive path 42 that includes traveling through die pad 14 for absorption into PCB 38. Accordingly, heat may be dissipated through die attach medium 28, die pad 14, and solder layer 40 before entering PCB 38, which operates as a heat sink. Although a great deal of the heat generated within packaged integrated circuit 10 may be dissipated along primary conductive path 42, one or more secondary paths 44 may provide additional means for dissipating heat from packaged integrated circuit 10. As one example, in addition to providing electrical connectivity between packaged integrated circuit 10 and printed circuit board 38, leadframe 16 may also conductively dissipate heat generated by region 15 and other features of die 12 by removing heat from packaged integrated circuit 10 and transferring the heat to PCB 38. Accordingly, the heat generated by die 12 and associated devices, such as region 15, may travel along lead wires 22 and 18 to leadframe 16 and ultimately into PCB 38. As another example, the heat generated by die 12 and associated devices may be dissipated into molded body 32 and exit packaged integrated circuit 10 through an outer surface of molded body 32. As will be described in more detail below, the thermal capacitance of the sum total of these thermal paths will affect the thermal response of die 12 to an electrical power supply.

The presence of defects at any interface between the described components of packaged integrated circuit 10 effects the ability of packaged integrated circuit 10 to dissipate heat generated during the operation of region 15 and/or other features formed on die 12. For example, where the bond between die 12 and die pad 14 includes one or more defects, primary conductive path 42 may have a reduced ability to efficiently dissipate heat. Such defects may include, for example, a void, air pocket, or stress-induced delamination in die attach medium 28 at the die to die pad interface 46. Such voids or other defects, when present, may result in the operation of die 12 at temperatures that near or exceed operating limits for regions 13 and 15, die 12, or packaged integrated circuit 10. In some instances, the increased operating temperatures of die 12 caused by the interruption in primary conductive path 42 may result in the failure of die 12.

In particular embodiments, defects in the various thermal paths may be detected by analysis of a heating curve. For example, thermal testing may be performed on packaged integrated circuit 10 to detect any voids and other defects along primary conductive path 42. During thermal testing, electrical connections are made to die 12 in order to apply an electrical pulse to packaged integrated circuit 10, determine die temperature, and determine the efficiency of thermal path 42. Since a defective packaged integrated circuit 10 operates at undesirably high operating temperatures, a defective packaged integrated circuit 10 may be identified and diagnosed where high operating temperatures are detected during the performance of the thermal tests. Additionally, high operating temperatures may cause packaged integrated circuit 10 to exhibit operational characteristics that are temperature dependant so that a local temperature can be derived from measuring its operation.

Returning to FIG. 1, packaged integrated circuit 10 is represented in relation to thermal testing system 8, and various components of packaged integrated circuit 10 are electrically connected to components of thermal testing system 8. For example, packaged integrated circuit 10 is electrically connected to a power source 60 and operates to receive power from power source 60. In particular embodiments, the power received from power source 60 includes A/C current that is applied to integrated circuit 10 for an optimized duration. In operation, it is not uncommon for a particular area or region of packaged integrated circuit 10 to have more heat generating capacity than other areas or regions. For example, region 15 may include a transistor or other array which generates significantly more heat than the surrounding area. Accordingly, the application of power to packaged integrated circuit 10 may result in the operation of region 15, which, in turn, may result in an increase in operational temperature of region 15. Thus, for thermal testing purposes, region 15 may be referred to as a heat source and will be hereinafter referred to as “heat source 15.” Where primary conductive path 42 is properly operating to dissipate heat from die 12 to PCB 38, the heat generated by heat source 15 during the testing process is largely dissipated along primary conductive path 42 and is removed from packaged integrated circuit 10.

Where voids or other defects along primary conductive path 42 reduce the efficiency of primary conductive path 42, however, the temperature of die 12 and features in die 12 may increase. Thus, in a defective packaged integrated circuit 10, as the temperature of heat source 15 increases, the temperature of die 12 and other components, features, and devices, such as device 13, also increases. The high operating temperatures of these components, features, and devices can indicate the presence of the defect where such temperatures are detected. Accordingly, for the obtainment of temperature measurements, packaged integrated circuit 10 includes one or more thermal sensors, such as region 13. In particular embodiments, thermal sensor 13 may include thermometers or other temperature sensing devices formed on and/or in circuit die 12. In other embodiments, it is contemplated that the thermal sensors may include power transistors, drive transistors, or other devices from which the temperature of circuit die 12 can be deduced. Thermal sensor 13 may monitor one or more monitor sites on die 12, obtain temperature or other performance readings from the one or more monitor sites, and provide the temperature or performance readings to a controller 66.

Controller 66 includes a processor or other computing device with circuitry and functionality for receiving and analyzing the one or more temperature measurements obtained as packaged integrated circuit 10 is heated by energy source 60. In operation, controller 66 may analyze the one or more temperature measurements obtained from thermal sensor 13 to determine whether packaged integrated circuit 10 includes defective components or paths. In particular embodiments, controller 66 may compare the obtained temperature measurements to a high temperature operating limit associated with packaged integrated circuit 10. Particular thermal behaviors of packaged integrated circuit 10 may be stored in a database 68 that is in communication with controller 66 and may be referenced by controller 66 to determine whether a tested integrated circuit 10 includes one or more defective components or paths. For example, if the particular type of packaged integrated circuit 10 typically operates at an ambient temperature on the order of 0 to 70° C., controller 66 may reference database 68 to obtain this information to determine that a tested integrated circuit 10 having a temperature measurement higher than 80° C. includes one or more defective components or paths.

In other embodiments, and as discussed above, the thermal behavior of packaged integrated circuit 10 may be derived by measuring operational characteristics of packaged integrated circuit 10. Because the operational characteristics exhibited by packaged integrated circuit 10 are temperature dependent, controller 66 may additionally or alternatively receive information about the operational performance of packaged integrated circuit 10. For example, the temperature measurements may be derived from measuring leakages of heat sensing element 13 or any parasitic diodes or other temperature affected structures or devices on die 12. To determine whether a tested integrated circuit 10 includes one or more defective components or paths, controller 66 may compare the performance level of region 13 to performance parameters associated with integrated circuits known to be without defects. Accordingly, controller 66 may reference database 68 to obtain performance parameters associated with the type of integrated circuit or device comprising integrated circuit 10 and region 13, respectively.

As discussed above, testing system 8 applies an electrical power pulse from power source 60 to increase the temperature of integrated circuit 10 for the obtainment of one or more temperature or performance readings. As is discussed in more detail below, the electrical power pulse may include a pulsed power flow. In particular embodiments, controller 66 may control the amount and rate of power applied to packaged integrated circuit 10. Thus, in addition to obtaining temperature and performance readings from packaged integrated circuit 10 for determining whether packaged integrated circuit 10 includes a one or more defective components or paths, controller 66 may also communicate with power source 60 to result in the generation of an appropriate amount of heat by heat source 15. In other embodiments, however, it is contemplated that one or both of the above described functionalities may be performed by a controller other than controller 66 that may be internal or external to testing system 8.

In a particular embodiment, the one or more temperature measurements may represent the temperature or performance of packaged integrated circuit 10 while in a dynamic state. Accordingly, as heat is generated by heat source 15, dynamic temperature or performance readings of thermal sensor 13 may be obtained at each of a plurality of predetermined increments of time. For example, temperature measurements and/or performance readings may be obtained from heat sensing element 13 at increments on the order of 5 to 50 milliseconds. In this manner, the rate at which the temperature of heat sensing element 13 rises may be obtained and a dynamic state may be established. Additionally or alternatively, as a dynamic test, cool-down time may be used as a measurement index. The rate of temperature change, whether positive or negative, may indicate the thermal capacity of the die at the measurement point.

The parameters associated with the dynamic state of packaged integrated circuit 10 may be used by controller 66 or another controller to determine whether packaged integrated circuit 10 includes one or more defective components or paths. In particular, defects in the various thermal paths may be detected by analysis of the heating curve. For example, the rate at which the temperature of heat packaged integrated circuit 10 rises may indicate to controller 66 whether the components or paths of packaged integrated circuit 10 are defective. For example, and as discussed above with regard to FIG. 2, where delamination or other defect is present at the die to die pad interface 46 or at the die pad to PCB interface 48, the thermal capacitance of die pad 14 may have a lesser affect on the temperature response. As a result, the rate at which the temperature of packaged integrated circuit 10 rises may be higher than the rate of increase associated with a packaged integrated circuit without such a defect. Accordingly, controller 66 may determine that a packaged integrated circuit 10 exhibiting a quicker rise in temperature may include one or more defective components or paths.

Sensitivity to a specific failure site can be improved by selecting a power duration to maximize this sensitivity. Thus, the time increment corresponding to the highest percentage difference between a known defective device and a known non-defective device may indicate the location of the defect. For example, the longer it takes for the difference to peak, the farther from the heat source is the defect site. In accordance with an embodiment of the present invention, this peak in the rate of increase in temperature (as compared to the rate in temperature increase of a like packaged integrated circuit 10 without a defect) may indicate to controller 66 that packaged integrated circuit 10 is defective. Furthermore, the timing of the peak may indicate the location of the defect site.

However, any application of power after the peak in the rate of increase in temperature may have the effect of polluting the thermal testing results. Accordingly, in addition to performing thermal tests on packaged integrated circuit 10 for detecting defective components or paths, testing system 8 may also be used to determine an optimized power duration for detecting a defect in a packaged integrated circuit 10, in particular embodiments. The optimized power duration may comprise an increment of time corresponding with the peak in the rate of increase in temperature associated with a particular type of packaged integrated circuit 10. Stated differently, the optimized power duration may correspond with the highest percentage change in temperature exhibited by a packaged integrated circuit 10 having one or more defects as compared to the change in temperature exhibited by a packaged integrated circuit 10 that is free of such defects. Thus, the optimized power duration may be the minimum amount of time that testing system 8 should apply power to heat packaged integrated circuit 10 to obtain temperature measurements and/or performance readings for detecting defects in a particular location.

For purposes of example only and not by means of limitation, the graph illustrated in FIG. 3A provides exemplary temperature measurements obtained for the determination of an optimized power duration for detecting a defect in an exemplary packaged integrated circuit 10. FIG. 3A includes a plot 72 representing temperature measurements associated with a defective integrated circuit and a plot 74 representing temperature measurement associated with a non-defective integrated circuit. In the illustrated example, the defective integrated circuit 10 included delamination in die attach medium 48. It can be seen from plots 72 and 74 that the temperature of the defective integrate circuit increases at a greater rate during at least a portion of the curve. As described below, defects in the defective integrated circuit may be detected by analyzing these heating curves.

In the illustrated example, Power was applied to the defective and non-defective integrated circuits for a duration of 205 milliseconds, and temperature measurements 70 were obtained at predetermined increments of 10 milliseconds from a thermal sensor formed in and/or on the defective integrated circuit. Line 72 represents the increase in temperature of the defective integrated circuit during the application of power. By contrast, line 74 represents the increase in temperature of the non-defective packaged integrated circuit during the application of power over the same period of time.

The difference in temperature between the defective packaged integrated circuit and the non-defective packaged integrated circuit may be graphed, as is illustrated by line 76 of FIG. 4B. For example, as described above, the temperature measurements of defective and non-defective packaged integrated circuits were approximately 27° C. and 25° C., respectively, after power was applied to the integrated circuits for a time increment of approximately 5 ns. Therefore, the difference in temperature between the defective and non-defective integrated circuits at approximately 5 ns is approximately 2.0° C., as is represented by point 78 on line 76. Similar calculations performed at each 10 milliseconds time increment may be made to generate the remaining points on line 76. For example, where the temperature measurements of the defective and non-defective integrated circuits were approximately equal to 45° C. and 39° C., respectively, after power was applied to the integrated circuits for a time increment of approximately 55 ns, controller 66 may calculate the difference in temperature between the defective and non-defective integrated circuits as approximately 6° C., as is represented by point 80. As still another example, where the temperature measurements of the defective and non-defective integrated circuits were approximately equal to 67° C. and 61° C., respectively, after power was applied to the integrated circuits for a time increment of approximately 205 ns, controller 66 may determine that the difference in temperature between the defective and non-defective integrated circuits is approximately 6° C., as is represented by point 82.

For the purposes of determining an optimized duration of power for detecting defective components or paths in integrated circuits of the type tested to obtain lines 72 and 74 of FIG. 4A, the difference in temperature between the defective and non-defective integrated circuits may be represented as a percentage of the temperature of the non-defective integrated circuit at each time increment, as is illustrated by line 84. For example, the point illustrated by reference numeral 86 may be calculated as:
Point 86=(2° C./25° C.)100=8%
where 2° C. represents the difference in temperature between the defective and non-defective integrated circuits at 5 milliseconds and 25° C. represents the temperature of the non-defective integrated circuit at 5 milliseconds. Point 88 may be calculated similarly as:
Point 88=(6° C./39° C.)100=15.4%
where 6° C. represents the difference in temperature between the defective and non-defective integrated circuits at 55 milliseconds and 39° C. represents the temperature of the non-defective integrated circuit at 55 milliseconds. Point 90 may be calculated similarly as:
Point 90=(6° C./61° C.)10=10%
where 6° C. represents the difference in temperature between the defective and non-defective integrated circuits at 205 milliseconds and 61° C. represents the temperature of the non-defective integrated circuit at 205 milliseconds.

From the information provided by line 84, controller 66 may determine the optimized duration of power specific to optimize the sensitivity of testing system 8 to detection of defective components or paths in integrated circuits of the same type. Specifically, for the example discussed above, the optimized power duration is represented by the peak on line 84. Thus, for the type of integrated circuits used in the described example, the optimized power duration is approximately 55 milliseconds. Accordingly, when performing thermal functionality tests on integrated circuits of this type, testing system 8 may apply power for a duration of approximately 55 milliseconds. After 55 milliseconds, the temperature of the tested integrated circuit may be obtained by controller 66. Controller 66 may then reference line 74 of FIG. 4A as stored in database 68 to determine the temperature of the exemplary non-defective integrated circuit at the optimized power duration. Thus, for the described example, controller 66 may determine that the temperature of the exemplary non-defective integrated circuit to be approximately 39° C. at 55 milliseconds.

Controller 66 may then compare the temperature of the tested integrated circuit to the temperature of the exemplary non-defective integrated circuit at the optimized power duration to determine whether the tested integrated circuit has one or more defective components or paths impeding the ability of the tested integrated circuit to dissipate heat. For example, where the temperature of the tested integrated circuit is less than or equal to 39° C. after power is applied to the tested integrated circuit for the optimized power duration of approximately 55 milliseconds, controller 66 may determine that the tested integrated circuit is not defective. Conversely, where the temperature of the tested integrated circuit is greater than 39° C. after power is applied to the tested integrated circuit for the optimized power duration of approximately 55 milliseconds, controller 66 may determine that the tested integrated circuit includes one or more defective components or paths impeding the ability of the tested integrated circuit to dissipate heat.

Where a defect is detected, controller 66 may determine the degree to which the tested integrated circuit is defective based on the temperature of the tested integrated circuit after power is applied to tested integrated circuit for the optimized power duration. For example, the higher the temperature of the tested integrated circuit above the reference point provided by line 74, the less the tested integrated circuit is able to dissipate heat. Accordingly, a temperature that is much greater than the reference point provided by line 74 may indicate to controller 60 that a larger defect or more defective component or path is present.

Accordingly, in various embodiments, testing system 8 may operate in the manner described to determine an optimized power duration for performing thermal functionality tests on packaged integrated circuits 10. The optimized power duration may be a sufficient span of time for the efficient measurement of the thermal capacitance of the components of packaged integrated circuits 10. In particular embodiments, the optimized power duration may be selected to be sensitive to the measurement of primary thermal path 42. The thermal functionality tests may detect the presence of any voids in the epoxy or other material adhering die 12 to die pad 14 or in the solder 40 adhering die pad 14 to PCB 38. In other embodiments, the optimized power duration may be conservatively selected to be sensitive to the measurement of additional thermal paths where it is recognized that such conservation may reduce the sensitivity of testing system 8 to shorter paths. Regardless, tested integrated circuits 10 found to have delamination and other defects may be removed from production such that they are not incorporated in to end products. As a result, the performance of end products including packaged integrated circuits 10 may be improved and operating temperatures reduced.

Although the present invention has been described in detail, it should be understood that various changes, alterations, substitutions, and modifications can be made to the teachings disclosed herein without departing from the spirit and scope of the present invention which is solely defined by the appended claims.

What is claimed is:

1. A method for determining an optimized pulse duration for detecting defects in integrated circuits, comprising:
providing a first integrated circuit known to be defective;
measuring the temperature of the first integrated circuit at a plurality of predetermined increments of time as a first power pulse is applied to the first integrated circuit;
providing a second integrated circuit known to be non-defective;
measuring the temperature of the second integrated circuit at the plurality of predetermined increments of time as a second power pulse is applied to the integrated circuit;
determining a difference in temperature between the first integrated circuit and the second integrated circuit at each of the plurality of predetermined increments; and
determining an optimized pulse duration for determining whether a third integrated circuit is defective, the optimized pulse duration comprising an increment of time corresponding with the greatest difference in temperature between the first integrated circuit and the second integrated circuit.

2. The method of claim 1, wherein measuring the temperature of the die of the first die package comprises:
measuring the performance of a feature of the first integrated circuit; and
associating a temperature with the first integrated circuit based on the performance of the feature.

3. The method of claim 2, wherein the feature comprises a transistor, digital to analog converter, computer processor, amplifier, digital signal processor, resistor, capacitor, or controller.

4. The method of claim 1, further comprising:
expressing the difference between the temperature of the first and second integrated circuits at each of the plurality of predetermined increments as a percentage of the temperature of the second integrated circuit at each of the plurality of predetermined increments; and
associating the optimized pulse duration with an increment of time corresponding with the highest percentage change in temperature.

5. The method of claim 11, wherein:
the first and second power pulses are applied for a duration on the order of 180-2000 milliseconds; and
the plurality of predetermined increments of time at which the temperatures of the first and second integrated circuits are measured are on the order of 5-50 milliseconds.

6. The method of claim 1 further comprising:
applying a third pulse of power for the optimized pulse duration to the third integrated circuit;
receiving an indication from the third integrated circuit of a temperature of the third integrated circuit after the third pulse of power is applied for the optimized pulse duration; and
determining whether the third integrated circuit has a defect based on the temperature of the third integrated circuit.

7. The method of claim 6, wherein receiving an indication from the third integrated circuit of the temperature comprises:
receiving a measure of performance of a feature associated with the third integrated circuit; and
associating a temperature with the third integrated circuit based on the performance of the feature.

8. The method of claim 6, further comprising:
determining that the third integrated circuit is defective if the temperature associated with the third integrated circuit after the third pulse of power is applied for the optimized pulse duration is more than a statistically determined limit based on the behavior of one or more known non-defective integrated circuits; and
determining that the third integrated circuit is non-defective if the temperature associated with the third integrated circuit after the third pulse of power is applied for the optimized pulse duration is less than or equal to the statistically determined limit based on the behavior of one or more known non-defective integrated circuits.

9. The method of claim 1, wherein the first and second integrated circuits each comprise a die supported on a die pad, the first and second integrated circuits mounted to a printed circuit board, the first integrated circuit having at least one void between a die of the first integrated circuit and a die pad comprises one or more voids disposed between the die and the die pad.

10. A method for detecting a defect in an integrated circuit using an optimized power pulse, comprising:
applying a first pulse of power to a first integrated circuit for an optimized pulse duration, the optimized pulse duration determined as a function of a difference in temperature between a second, defective integrated circuit and a third, non-defective integrated circuit;
measuring the temperature of the first integrated circuit after the first pulse of power is applied to the first integrated circuit for the optimized pulse duration; and
determining whether the first integrated circuit is defective based on the temperature of the first integrated circuit.

11. The method of claim 9, wherein determining the optimized pulse duration comprises:
applying a second pulse of power to the second, defective integrated circuit;
measuring the temperature of the second integrated circuit at a plurality of predetermined increments of time as the second pulse of power is applied to the second integrated circuit;
applying a third pulse of power to the third, non-defective integrated circuit;
measuring the temperature of the third integrated circuit at the plurality of predetermined increments of time as the third pulse of power is applied to the third integrated circuit;
determining a difference in temperature between the second and third integrated circuits at each of the plurality of predetermined increments;
expressing the difference at each of the plurality of predetermined increments as a percentage of the temperature of the third integrated circuit; and
associating the optimized pulse duration with an increment of time corresponding to the highest percentage change in temperature.

12. The method of claim 10, wherein measuring the temperature of the first integrated circuit comprises:
measuring the performance of a feature of the first integrated circuit; and
associating a temperature with the first integrated circuit based on the performance of the feature.

13. The method of claim 10, wherein determining whether the first integrated circuit is defective comprises:
determining that the first integrated circuit is defective if the temperature associated with the first integrated circuit after the first pulse of power is applied for the optimized pulse duration is more than a statistically determined limit based on the behavior of one or more known non-defective integrated circuits; and
determining that the first integrated circuit is non-defective if the temperature associated with the first integrated circuit after the first pulse of power is applied for the optimized pulse duration is less than or equal to the statistically determined limit based on the behavior of one or more known non-defective integrated circuits.

14. The method of claim 10, wherein:
the first integrated circuit comprises a die supported on a die pad;
the first integrated circuits mounted to a printed circuit board; and
determining whether the first integrated circuit is defective comprises determining whether one or more voids are disposed between a die of the first integrated circuit and a die pad of the first integrated circuit.

15. A testing system for detecting defects in an integrated circuit, comprising:
a power source operable to apply a first pulse of power to a first integrated circuit package for an optimized pulse duration, the optimized pulse duration determined as a function of a difference in temperature between a second, defective integrated circuit and a third, non-defective integrated circuit;
a controller in communication with the first integrated circuit and operable to:
obtain a temperature measurement of the first integrated circuit after the first pulse of power is applied to the first integrated circuit for the optimized pulse duration; and
determine whether the first integrated circuit is defective based on the temperature measurement of the first integrated circuit.

16. The testing system of claim 15, wherein the controller is further operable to determine the optimized pulse duration by:
applying a second pulse of power to the second, defective integrated circuit;
measuring the temperature of the second integrated circuit at a plurality of predetermined increments of time as the second pulse of power is applied to the second integrated circuit;
applying a third pulse of power to the third, non-defective integrated circuit;
measuring the temperature of the third integrated circuit at the plurality of predetermined increments of time as the third pulse of power is applied to the third integrated circuit;
determining a difference in temperature between the second and third integrated circuits at each of the plurality of predetermined increments;
expressing the difference at each of the plurality of predetermined increments as a percentage of the temperature of the third, non-defective integrated circuit; and
associating the optimized pulse duration with an increment of time corresponding to the highest percentage change in temperature.

17. The testing system of claim 15, wherein the controller is operable to obtain the temperature measurement of the first integrated circuit by:
measuring the performance of a feature of the first integrated circuit; and
associating a temperature with the first integrated circuit based on the performance of the feature.

18. The testing system of claim 17, where the feature comprises a transistor, digital to analog converter, computer processor, amplifier, digital signal processor, resistor, capacitor, or controller.

19. The testing system of claim 15, wherein the controller is operable to determine whether the first integrated circuit is defective by:
determining that the first integrated circuit is defective if the temperature associated with the first integrated circuit after the first pulse of power is applied for the optimized pulse duration is more than a statistically determined limit based on the behavior of one or more known non-defective integrated circuits; and
determining that the first integrated circuit is non-defective if the temperature associated with the first integrated circuit after the first pulse of power is applied for the optimized pulse duration is less than or equal to the statistically determined limit based on the behavior of one or more known non-defective integrated circuits.

20. The testing system of claim 15, wherein:
the first integrated circuit comprises a die supported on a die pad;
the first integrated circuits mounted to a printed circuit board; and
the controller is operable to determine whether the first integrated circuit is defective by determining whether one or more voids are disposed between a die of the first integrated circuit and a die pad of the first integrated circuit.
